(19) United States
(12) Patent Application Publication
(10) Pub. No.: US 2013/0093335 A1
(43) Pub. Date: Apr. 18, 2013

(54) A COLOR TUNABLE LAMP INCLUDING A CONTROL DEVICE WITH A RELATIVE FLUX SENSOR

(71) Applicants: Lucius Theodorus Vinkenvleugel, Veldhoven (NL); James Joseph Anthony McCormack, Eindhoven (NL); Jorgen Meeusen, Eindhoven (NL)

(72) Inventors: Lucius Theodorus Vinkenvleugel, Veldhoven (NL); James Joseph Anthony McCormack, Eindhoven (NL); Jorgen Meeusen, Eindhoven (NL)

(21) Appl. No.: 13/805,699

(22) PCT Filed: Jun. 17, 2011
(86) PCT No.: PCT/IB2011/052648

§ 371 Date: Dec. 20, 2012

(30) Foreign Application Priority Data
Jun. 24, 2010 (EP) 1016710.5

(51) Int. Cl. H05B 37/02

(52) U.S. Cl. CPC H05B 37/02
USPC 315/158

(57) ABSTRACT

A relative flux sensor (122) and a method of characterizing characteristics of light emitters are provided. The relative flux sensor (122) comprises a color point sensor (108) and a sensor color (118). The color point sensor (108) measures a color point in a color space of light emitted by a light source (101) comprising a first light emitter (102) for emitting light of a first color and a second light emitter (114) for emitting light of a second color being different from the first color. The light source (101) is arranged for emitting light of a controllable color, being a mix of light of the first color and light of the second color. The sensor controller (118) is coupled to the color point sensor (108) for receiving a measuring signal and is arranged for i) providing a first signal to the light source (101), the first signal comprising a dimming factor D1 and a dimming factor D2, the dimming factor D1 and the dimming factor D2 indicating a fraction of a maximum flux of the first light emitter (102) and the second light emitter (114), respectively, and receiving the measuring signal representing a first color point when the light source (101) emits light according to the first signal, wherein at least one of the dimming factors D1 and D2 is different from 0, ii) providing a second signal to the light source (101), the second signal comprising a dimming factor D4 and a dimming factor D5, the dimming factor D4 and the dimming factor D indicating a fraction of the maximum flux of the first light emitter (102) and the second light emitter (114), respectively, and receiving the measuring signal representing a second color point when the light source (101) emits light according to the second signal, wherein both dimming factors D4 and D5 are different from 0, iii) calculating within a model of the color 20 space a ratio between a maximum flux of the first light emitter (102) and a maximum flux of the second light emitter (114) on the basis of the first color point, the second color point, the dimming factors D1, D2, D4 and D5.

### FIELD OF THE INVENTION

The invention relates to the field of flux sensors.

### BACKGROUND OF THE INVENTION

In a color-tunable lamp, colors are created by mixing the light of at least two light emitters which each emit light of a different color. A first light emitter emits, for example, light of a first color which may be defined by a first color point (x1, y1) in a color space. A second light emitter emits, for example, light of a second color which may be defined by a second color point (x2, y2) in the color space. The emission of a specific amount of light of the first color relative to the emission of a specific amount of light of the second color, causes a specific mixed color defined by the third color point (x12, y12) to be emitted, which is located in between the first color point and the second color point on a line through the first color point and the second color point. By accurately controlling the ratio between the amount of light emitted by the first light emitter and the amount of light emitted by the second light emitter, all colors in between the first color point and the second color point on a line through the first color point and the second color point may be created. For example, if the first light emitter emits substantially more light than the second light emitter, the third color point is located relatively close to the first color point on the line through the first color point and the second color point. Color spaces are abstract spaces wherein the different colors are found at a specific position in the color space. Color spaces are based on a mathematical color space model, which provides relations between physical parameters of spectra of wavelengths and the coordinates of colors in the color space. These relations in the color space model are used by a controller of a color-tunable lamp such that a specific color is emitted. A well-known color space model is the CIE XYZ color space, created by the International Commission on Illumination. The first defined CIE XYZ color space is from 1931. The model is based to a large extent on the perception of color by the human eye.

Frequently, the color-tunable lamp comprises three light emitters which each emit light of a different color. Such a color-tunable lamp is capable of emitting light of a color which is located in a triangle of the color space defined by the color points of each one of the three light emitters.

In response to a user-input, which defines a desired color, a controller of the color-tunable lamp calculates at which intensity level the individual light emitters of the tunable lamp have to emit light to create light in accordance with the user-input. Such controllers are known and their operation is based on the mathematical representation of the color space. The controllers have to receive parameters of the light emitters of the color-tunable lamp to be able to control the light emitters reliably. These parameters are, for each light emitter, the color point at which the light emitter emits light and the flux of the light emitter when the light emitter is controlled to emit at its maximum light intensity. The parameters per light emitter are often indicated by a 3-tuple (x, y, Y), wherein (x, y) is the color point of the light emitted by the light emitter and Y is the flux of the light emitter when being controlled to emit at its maximum light intensity. It is to be noted that the light emitter is controlled to emit at its maximum light intensity when the light emitter receives an amount of power that is specified by the manufacturer as the maximum power that may be received by the light emitter.

If the color-tunable lamp has to be controlled more accurately, especially when the emitted color of the color-tunable lamp has to be controlled accurately while the lamp emits at a relatively low light intensity, more parameters have to be known of each one of the light emitters. A dimming curve per light emitter should preferably be known by the controller. The dimming curve represents the relation between the electrical signal supplied to the light emitter, for example, a voltage, a current or a specific amount of power, and the amount of emitted light, often expressed as the flux of the emitted light. If the controller knows the dimming curves and the color point of each one of the light emitters, the controller is capable of controlling the color-tunable light such that light of an accurately controlled color is emitted at light intensities which are lower than the maximum intensity.

The manufacturing specifications of the light emitters, as provided by the manufacturer of the light emitters, are for example used by the controller of a color-tunable lamp. In another example, a sample of a batch of light emitters is analyzed and the results of the measurements are the used parameters of the light emitters. In another example, each one of the light emitters is individually analyzed before the light emitters are incorporated in the color-tunable lamp. However, the actual characteristics of the light emitter may differ from the characteristics that are used by the controller. For example, the light emitter may deviate from the manufacturing specifications, or deviate from the light emitters of the sample of which the characteristics were measured, or deviate over time because of drift and degradation.

Published patent application US2008/0225520A1 discloses methods of defining operational limitations and discloses a lighting system and control of a lighting system comprising at least three light sources which individually emit light of a different color. The determination of the characteristics of the light sources of the lighting system is based on measuring, with a calibrated light intensity sensor, a series of maximum attainable light intensities. These measurements especially comprise the maximum attainable light intensities when only one of the light sources is switched on, the maximum attainable light intensities when two of the light sources are switched on, and the maximum attainable light intensity when three light sources are switched on. The measured maximum attainable light intensities define a maximum three-dimensional gamut representing the color that may be emitted by the lighting system. The light sources are LEDs which emit light into an optical cavity which has the shape of one half of a sphere. The interior surface of the optical cavity is diffusely highly reflective. The optical cavity has an aperture through which the light is emitted into the ambient of the lighting system. Close to the aperture a sensor measures the emitted light intensity. The volume of the optical cavity is of an integrating type, which is required to accurately measure the emitted light intensity of the combination of LEDs.

The calibrated light intensity sensor of the cited patent application is a relatively expensive part of the system. Furthermore, to measure the maximum light intensity accurately, light from the pluralities of light emitters has to be emitted into a so-termed integrating sphere or other integrating shape, which limits the possible designs of a light source comprising a plurality of light emitters. In the cited patent application, the interior of a half sphere is used as an integrating space which emits the light into the ambient through an aperture. Thus, a relatively large lighting system is obtained because of the size of the half spheres. Hence, the method and system of the cited patent application, which are used to characterize the light emitters of the lighting system, are too expensive.

### SUMMARY OF THE INVENTION

It is an object of the invention to provide a method and a system for characterizing light emitters of a light source which is less expensive than the known systems.

A first aspect of the invention provides a relative flux sensor as claimed in claim 1. A second aspect of the invention provides a color-tunable lamp control device as claimed in claim 11. A third aspect of the invention provides a color-tunable lamp as claimed in claim 12. A fourth aspect of the invention provides a luminaire as claimed in claim 13. A fifth aspect of the invention provides a method of characterizing relative fluxes as claimed in claim 14. A sixth aspect of the invention provides a computer program product as claimed in claim 15. Advantageous embodiments are defined in the dependent claims.

A relative flux sensor in accordance with the first aspect of the invention comprises a color point sensor, a sensor controller and an output means. The color point sensor is arranged to measure a color point in a color space of light emitted by the light source which comprises a first light emitter and a second light emitter. The first light emitter emits light of a first color. The second light emitter emits light of a second color being different from the first color. The light source is arranged to emit light of a controllable color being a mix of light of the first color and light of the second color. The sensor controller is coupled to the color point sensor for receiving a measuring signal. The sensor controller is arranged for i) providing a first signal to the light source, the first signal comprising a dimming factor D1 and a dimming factor D2, the dimming factor D1 and the dimming factor D2 indicating a fraction of a maximum flux of the first light emitter and the second light emitter, respectively, and receiving the measuring signal representing a first color point when the light source emits light according to the first signal, wherein at least one of the dimming factors D1 and D2 is different from 0, ii) providing a second signal to the light source, the second signal comprising a dimming factor D4 and a dimming factor D5, the dimming factor D4 and the dimming factor D5 indicating a fraction of the maximum flux of the first light emitter and the second light emitter, respectively, and receiving the measuring signal representing a second color point when the light source emits light according to the second signal, wherein both dimming factors D4 and D5 are different from 0, iii) calculating within a model of the color space a ratio between a maximum flux of the first light emitter and a maximum flux of the second light emitter on the basis of the first color point, the second color point, the dimming factors D1, D2, D4 and D5.

When mixing a specific amount of light of a first color with a specific amount of light of a second color, a well-defined third color is obtained. Relations of the model of the color space provide relations to calculate the color point of the third color. The relative flux sensor according to the first aspect of the invention measures two color points when the light source emits different mixes of light of the first color and light of the second color. The measured color points and the dimming factors provide enough information to calculate, on the basis of the relations of the model of the color space, the ratio between the maximum light intensity that may be emitted by the first light emitter and the maximum light intensity that may be emitted by the second light emitter.

The inventors realized that controllers of color-tunable lamps do not need to know exactly the maximum flux output for each individual light emitter, but they do have to know the ratio between the two maximum fluxes of the light emitters. A well-defined color is emitted by the color-tunable lamp when the color-tunable lamp is controlled to emit a specific amount of light of the first color relative to a specific amount of light of a second color; thus, knowing the ratio between the maximum fluxes of the light emitters is sufficient. Further, the controllers generate signals having values ranging between a minimum and a maximum, but the exact matching of the minimum and maximum value to a specific quantity of light is also not known by the controllers. It is only known that the light emitter emits at a maximum intensity when the light source of the color-tunable lamp receives a signal comprising the maximum value, and it is known that the light emitter does not emit light when it receives a signal comprising the minimum value. Thus, the controllers generate signals with a normalized value and therefore it is not necessary to know the exact values of the flux emitted by the light emitters. By knowing the ratio between the maximum fluxes of the light emitters, it is possible to control the amount of light emitted by the first light emitter relative to the amount of light emitted by the second light emitter to obtain a specific emitted color.

Thus, the relative flux sensor is able to determine characteristics of the light emitters of the light source which may be used by a control device of a color-tunable lamp to accurately control the color emitted by the color-tunable lamp.

The relative flux sensor comprises only a color point sensor for performing measurements. A color point sensor is a relatively cheap piece of hardware, while a flux sensor which measures the exact flux of light is more expensive. Further, measuring the color point of the emitted light may be done by positioning the sensor somewhere in the bundle of light emitted by the light source, and does not require the use of an integrating space for performing the measurement of the total flux, which reduces the cost of the light source. Thus, the relative flux sensor is capable of obtaining reliable information about the light emitters of the light source at relatively low cost.

The relative flux sensor may be spatially separated with respect to the light source and does not have to be integrated in the light source. The only requirement is that the light source is capable of receiving a signal comprising a first dimming factor and comprising a second dimming factor to control the light emission of the first light emitter and the second light emitter, respectively. Thus, the light source may also be seen as a black box which receives the first signal and the second signal and which emits light according to the signals. Subsequently, the device is capable of measuring the color points and determining relative fluxes from light emitters of the (black box) light source. This information may subsequently be used for controlling the (black box) light source in order to obtain an emission of light by the (black box) light source at an accurately controlled color. Hence, the method provides an opportunity to use, for example, light sources of different manufacturers in a color-tunable lamp without reducing the accuracy of the color tunable lamp.

The dimming factors are defined relative to the maximum flux that may be emitted by the respective light emitters. If the dimming factor is 0, or 0%, the light emitter does not emit at all. If the dimming factor is 1, or 100%, the light emitter emits its maximum flux. If the dimming factor is e.g. 80%, it is expected that the light emitter emits 80% of its maximum flux. The maximum flux is the maximum flux that may be emitted under normal operation. Each light emitter is designed and manufactured to emit a maximum flux, given a set of operational characteristics, such as the availability of cooling means, etc. The light emitters may be driven to emit maximum flux by providing a specific voltage, specific current or a specific amount of power. Although it might be theoretically possible to provide a higher voltage, larger current or more power, the meaning of maximum flux in the context of this invention is the maximum flux that may be emitted by the light emitter during normal operation.

In this context, light of the first color may be light of a first predefined spectrum and light of the second color may be light of a second predefined spectrum. The first predefined spectrum of light is different from the second predefined spectrum of light and therefore a viewer will experience the first color to be different from the second color. The spectra may comprise a single wavelength of light or a plurality of wavelengths. Further, the predefined spectra are not limited to the spectrum which is visible to the human eye.

The combination of dimming factors (D1, D2) is different from the combination of dimming factors (D4, D5) and thus the two color points are different.

In an embodiment, the sensor controller is further arranged to provide a third signal to the light source, the third signal comprising a dimming factor Da substantially equal to 0% and the dimming factor Db substantially equal to 100%, the dimming factor Da and the dimming factor Db indicating a fraction of the maximum flux of the first light emitter and the second light emitter, respectively, and receiving the measuring signal representing a third color point when the light source emits light according to the third signal. The dimming factor D1 is substantially equal to 100%, the dimming factor D2 is substantially equal to 0%. The step of calculating the ratio between the maximum flux of the first light emitter and the maximum flux of the second light emitter is further based on the third color point and the dimming factors Da and Db.

Thus, the first color point is the exact color point of the first light emitter, and the third color point is the exact color point of the second light emitter. The second color point is in between the first color point and the third color point on a line through the first color point and the second color point. Depending on the amount of light emitted by the first light emitter relative to the amount of light emitted by the second light emitter when the second signal is provided to the light source, the second color point is a specific color point. Thus, knowing the first color point, the third color point, and the specific position of the second color point allows the calculation of the ratio between the maximum flux of the first light emitter and the maximum flux of the second light emitter. The model of a color space provides relations to determine the relative maximum fluxes of the first light emitter and of the second light emitter.

The controllers of color-tunable lamps also have to know the color points of the light emitters of the light source. Color points of light emitters may deviate from the specifications of the light emitters and the color point may drift over time because of deterioration of the light emitter. The embodiment has the additional advantage that the exact color points of the first light emitter and of the second light emitter are measured and therefore the color tunable lamp may be controlled more accurately.

In an embodiment, the dimming factor D4 is substantially equal to 0% and the dimming factor D5 is substantially equal to 100%.

Further, all dimming factors are 0% or 100% according to this embodiment, which means that the light emitters do not emit at all or emit at maximum intensity. Thus, the light emission of the light emitters is not influenced by a possible dimming curve. The light source may comprise, for example, driving electronics which provide a voltage or a current to the light emitters when a signal comprising a specific dimming factor is received. Often, components of the driving electronics do not have linear characteristic, and therefore a fraction of the maximum light intensity emitted by the light emitter may differ from the fraction of the maximum light intensity indicated by the dimming factor. Further, the light emitters may have a non-linear light emission characteristic. Such non-linear behavior does not influence the measurements of the embodiment and therefore the measurements are more accurate.

In a further embodiment, the first color point, the second color point and the third color point are represented by respective coordinates (x1, y1), (x12, y12) and (x2, y2) in a color space of a CIE xyz color space model, and wherein the ratio between the maximum flux Y1 of the first light emitter and the maximum flux Y2 of the second light emitter is calculated by

$$ratio = \frac{Y 1}{Y 2} = \frac{1 - \frac{x 2}{y 2} \cdot \frac{y 12}{x 12}}{\frac{x 1}{y 1} \cdot \frac{y 12}{x 12} - 1}$$

The CIE xyz color space model is a well known color model which models all the colors which may be seen by the human eye in a color space. In the color space of the CIE xyz color space model, all the colors may be described by an x-y coordinate in an x-y-plane. The provided formula for calculating the ratio can be derived from the relations of the CIE xyz color space model if the coordinates of the first color point, the second color point, the third color point, and the dimming factors are known.

The formula to calculate the ratio is relatively simple and, thus, the calculation of the ratio does not cost much processing power. The sensor controller of the relative flux sensor may therefore comprise a relatively simple means for calculating the ratio.

In a further embodiment, the calculating of the ratio between the maximum flux of the first light emitter and the maximum flux of the second light emitter comprises the calculation of a color point of the first light emitter and the calculation of a color point of the second light emitter. The relative flux sensor is a cost effective sensor for determining the color points. Knowing the color points of the individual light emitters is advantageous because an additional characteristic of the light emitters is obtained which is important information for controllers of color-tunable lamps to control the color-tunable lamp accurately.

In another embodiment, the light source further comprises a third light emitter emitting a third color being different from the first color and being different from the second color. The first signal further comprises a dimming factor D3 indicating a fraction of a maximum flux of the third light emitter. The second signal further comprises a dimming factor D6 indicating a fraction of the maximum flux of the third light emitter. The sensor controller is further arranged for providing a fourth signal to the light source, the fourth signal comprising a dimming factor D7, a dimming factor D8 and a dimming factor D9, the dimming factor D7, the dimming factor D8 and the dimming factor D9 indicating a fraction of the maximum flux of the first light emitter, the second light emitter and the third light emitter, respectively, and receiving the measuring signal representing a fourth color point when the light source emits light according to the fourth signal. And, the calculating of the ratio between the maximum flux of the first light emitter and the maximum flux of the second light emitter is further based on the dimming factors D3, D6, D7, D8 and D9 and the fourth color point.

In many practical light sources three light emitters are used to be able to emit many more colors. If a color-tunable lamp comprises such a light source, the control device of the color-tunable lamp has to know the characteristics of all the light emitters, especially their maximum fluxes. By measuring three different color points when the light source emits different colors being different combinations of the first color, the second color and the third color, and by knowing the dimming factors when the respective color points are measured, one may calculate the ratio between the maximum flux of the first light emitter and the maximum flux of the second light emitter. The color space model provides formulas from which one may deduct formulas to calculate the ratio. The relative flux sensor is a relatively simple and cost-effective device for characterizing light sources, which comprises three light emitters. It is to be noted that the combinations of dimming factors (D1, D2, D3), (D4, D5, D6) and (D7, D8, D9) are different from each other such that three different color points are obtained.

In a further embodiment, the sensor controller is further arranged for calculating a ratio between the maximum flux of the first light emitter and a maximum flux of the third light emitter, based on the dimming factors D1, D2, D3, D4, D5, D6, D7, D8 and D9, and the first color point, the second color point and the fourth color point.

If the three color points are known as well as their respective dimming factors, it is also possible to calculate the ratio between the maximum flux of the first light emitter and the maximum flux of the third light emitter. Thus, on the basis of the embodiment, all ratios between the maximum fluxes of the three light emitters of the light sources may be determined. Alternatively, in an embodiment, the sensor controller is further arranged for calculating a ratio between the maximum flux of the second light emitter and the maximum flux of the third light emitter, based on the dimming factors D1, D2, D3, D4, D5, D6, D7, D8 and D9, and the first color point, the second color point and the fourth color point.

In a further embodiment, the sensor controller is further arranged to provide a fifth signal to the light source, the fifth signal comprising dimming factors Dc being substantially equal to 0%, Dd being substantially equal to 100% and De being substantially equal to 0%, the dimming factor Dc, the dimming factor Dd and the dimming factor De indicating a fraction of the maximum light flux of the first light emitter, the second light emitter and the third light emitter, respectively, and receiving the measuring signal representing a fifth color point when the light source emits light according to the fifth signal. The dimming factors D1, D9 are 100% and the dimming factors D2, D3, D7, and D8 are 0%. The calculation of the ratio between the maximum flux of the first light emitter and the maximum flux of the second light emitter is further based on the fifth color point and the dimming factors Dc, Dd and De. In an additional embodiment, the calculation of the ratio between the maximum flux of the first light emitter and the maximum flux of the third light emitter is further based on the fifth color point and the dimming factors Dc, Dd and De.

The measured first color point, the measured fourth color point and the measured fifth color point are exactly the color points of the first light emitter, the third light emitter and the second light emitter, respectively. The second color point is the result of combining the first color, the second color and the third color. Depending on the dimming factors D4, D5 and D6, a specific second color point is obtained. As discussed before, it is advantageous, in addition to calculating the ratios between the maximum light intensities of the light emitters, to measure the exact color points of the light emitters.

In a further embodiment, dimming factors D3, D4 and D5 are substantially equal to 100%. In this embodiment, the influencing of the measurements by non-linear behavior of the light emitters or driving electronics of the light source is avoided as much as possible.

In an embodiment, the first color point, the second color point, the fourth color point and the fifth color point are represented by the respective coordinates (x1, y1), (x2, y2), (x4, y4) and (x5, y5) in a color space of a CIE xyz color space model, the ratio between the maximum flux Y1 of the first light emitter and the maximum flux Y2 of the second light emitter being calculated by:

$${ratio}_{1 - 2} = \frac{Y 1}{Y 2} = \frac{y 1 \cdot ( x 5 \cdot y 2 - x 2 \cdot y 5 + x 2 \cdot y 4 - x 4 \cdot y 2 + x 4 \cdot y 5 - x 5 \cdot y 4 )}{y 5 \cdot ( x 4 \cdot y 2 - x 2 \cdot y 4 + x 2 \cdot y 1 - x 1 \cdot y 2 + x 1 \cdot y 4 - x 4 \cdot y 1 )}$$

and/or the ratio between the maximum flux Y1 of the first light emitter and the maximum flux Y3 of the third light emitter being calculated by:

$${ratio}_{1 - 3} = \frac{Y 1}{Y 3} = \frac{y 1 \cdot ( x 5 \cdot y 2 - x 2 \cdot y 5 + x 2 \cdot y 4 - x 4 \cdot y 2 + x 4 \cdot y 5 - x 5 \cdot y 4 )}{y 2 \cdot ( x 5 \cdot y 4 - x 4 \cdot y 5 + x 4 \cdot y 1 - x 1 \cdot y 4 + x 1 \cdot y 5 - x 5 \cdot y 1 )}$$

In another embodiment, the sensor controller is further arranged for i) defining a plurality of dimming factors in between a minimum and a maximum dimming factor, ii) iteratively performing for each one of the plurality of defined dimming factors the steps of providing the third signal to the light source, receiving the measuring signal representing the third color point, and calculating a dimming ratio between the maximum flux of the first light emitter and a dimmed flux of the second light emitter, wherein the dimming factor D5 iterates through the plurality of defined dimming factors in the subsequent iterations, iii) calculating points of a dimming curve of the second light emitter on the basis of the plurality of defined dimming factors, the plurality of the calculated dimming ratios between the maximum flux of the first light emitter and the flux of the second light emitter and the calculated ratio between the maximum flux of the first light emitter and the maximum flux of the second light emitter. In a further embodiment, the sensor controller is further arranged for reconstructing the dimming curve of the second light emitter on the basis of the calculated points of the dimming curve.

During the iterations, the first light emitter receives always a dimming factor of 100% which indicates the emission of light at the maximum light intensity. Thus, the amount of light emitted by the first light emitter is kept constant. During the iterations, the dimming factor D5 indicates another light intensity which must be emitted by the second light emitter and thus the flux of the second light emitter is dimmed. On the basis of the previously calculated ratio between the maximum flux of the first light emitter and the maximum flux of the second light emitter, and the changed dimming factor D5 which indicates a specific fraction of the maximum light intensity, one would expect, when the second light emitter has a linear dimming curve, a specific calculated dimming ratio in each of the iterations. The calculation of the dimming ratio is performed similarly to the calculation of the ratio between the maximum fluxes. However, when the dimming ratios that are based on the real measurements deviate from the expected dimming ratios, the dimming curve of the second light emitter is not linear. The calculated dimming ratios which are based on the real measurements are used to calculate points of the dimming curve. The plurality of points may be used to reconstruct the dimming curve, using interpolation, extrapolation and/or curve fitting.

It is advantageous to know the dimming curve of the light emitters, because it allows more accurate controlling of a color-tunable lamp. Further, the dimming curve is determined by means of the relatively simple and cost-effective relative flux sensor and thus it is relatively easy and relatively cheap to determine the dimming curve. Especially when the light source is considered to be a black box which comprises driving electronics to provide power to the light emitters of the light source in dependence on received signals, it is advantageous to determine the dimming curve of the light emitter to know how much light the light emitter emits when a specific dimming factor is applied which indicates a specific fraction of the maximum flux. Thus, the response of the light source, including the driving electronics, is characterized. Each manufacturer implements the driving electronics differently and therefore light sources of different manufacturers may behave differently. The relative flux sensor provides a relatively simple and cost-effective solution which may be used to determine the behavior of light sources of different manufacturers.

In an embodiment, the relative flux sensor further comprises an output means for providing an output to a control device of a color-tunable lamp comprising the light source. The output comprises the first color point, the second color point and the ratio between the maximum flux of the first light emitter and the maximum flux of the second light emitter. The output may comprise more information, like for example a dimming curve of one of the light emitters. By providing the output to a control device of a color-tunable lamp, the control device is capable of controlling the color of the light emitted by the light source more accurately.

The control device for a color-tunable lamp according to the second aspect of the invention comprises the relative flux sensor according to the first aspect of the invention and a light source controller. The light source controller is arranged for i) receiving the first color point, the second color point and the ratio between the maximum flux of the first light emitter and the maximum flux of the second light emitter, ii) receiving a user-input indicating a color to be emitted by the color tunable lamp, iii) generating a sixth signal comprising a dimming factor D10 and a dimming factor D11 to obtain, when the light source emits light according to the sixth signal, an emitted color indicated by the user-input, the generating being performed on the basis of the first color point, second color point and the ratio between the maximum flux of the first light emitter and the maximum flux of the second light emitter, the dimming factor D10 and the dimming factor D11 indicating a fraction of the maximum flux of the first light emitter and the second light emitter, respectively, and iv) providing the sixth signal to the light source of a color tunable lamp.

The control device is capable of generating the sixth signal which results in the emission of a color which accurately matches the color of the user-input. Means for the generation of such a signal in dependence on a user-input are known, and in general the means which are involved in such a generation require additional input comprising characteristics of the light emitters of the light source. The received first color point, the second color point, and the ratio between the maximum flux of the first emitter and the maximum flux of the second emitter are sufficient to control the light emitters of the light source accurately to obtain an emitted color in accordance with the indicated color of the user-input. If more information is provided, for example the dimming curves of the light emitters, the sixth signal may even be generated more accurately.

The control device for the color tunable lamp according to the second aspect provides the same benefits as the relative flux sensor according to the first aspect of the invention and has similar embodiments with similar effects.

According to a third aspect of the invention, a color-tunable lamp is provided which comprises a light source and a control device for a color-tunable lamp according to the second aspect of the invention. The light source comprises a first light emitter for emitting light of a first color and a second light emitter for emitting light of a second color being different from the first color. The light source is arranged for emitting light according to a received signal that comprises dimming factors which indicate a fraction of the maximum flux of the respective light emitters to be emitted by these light emitters.

The color-tunable lamp according to the third aspect provides the same benefits as the control device for the color-tunable lamp according to the second aspect of the invention and has similar embodiments with similar effects.

According to a fourth aspect of the invention, a luminaire is provided which comprises the color-tunable lamp according to the third aspect of the invention.

The luminaire according to the fourth aspect provides the same benefits as the relative color-tunable lamp control device according to the third aspect of the invention and has similar embodiments with similar effects.

According to a fifth aspect of the invention, a method of characterizing relative fluxes of a light source is provided. The light source comprises a first light emitter to emit light of a first color and a second light emitter to emit light of a second color being different from the first color. The light source is arranged to emit light of a controllable color being a mix of light of the first color and light of the second color. The method comprises the steps of i) providing a first signal to the light source, the first signal comprising a dimming factor D1 and a dimming factor D2, the dimming factor D1 and the dimming factor D2 indicating a fraction of the maximum light intensity of the first light emitter and the second light emitter, respectively, and receiving a measuring signal representing a first color point in a color space when the light source emits light according to the first signal, wherein at least one of the dimming factors D1 and D2 is different from 0, ii) providing a second signal to the light source, the second signal comprising a dimming factor D4 and a dimming factor D5, the dimming factor D4 and the dimming factor D5 indicating a fraction of the maximum flux of the first light emitter and the second light emitter, respectively, and receiving the measuring signal representing a second color point in the color space when the light source emits light according to the second signal, wherein both dimming factors D4 and D5 are different from 0, iii) calculating within a model of the color space a ratio between a maximum flux of the first light emitter and a maximum flux of the second light emitter on the basis of the first color point, the second color point, the dimming factors D1, D2, D4 and D5.

The method according to the fifth aspect of the invention provides the same benefits as the relative flux sensor according to the first aspect of the invention and has similar embodiments with similar effects as the corresponding embodiments of the system.

It is to be noted that the step of calculating the ratio between the maximum flux emitted by the first light emitter and the maximum flux emitted by the second light emitter has to be performed as a last step. The other steps of the method may be performed in another order as long as they are performed before the step of calculating the ratio.

According to a sixth aspect of the invention, a computer program product is provided comprising instructions for causing a processor system to perform the method according to the fifth aspect of the invention.

The computer program product according to the sixth aspect of the invention provides the same benefits as the relative flux sensor according to the first aspect of the invention and has similar embodiments with similar effects as the corresponding embodiments of the system.

These and other aspects of the invention are apparent from and will be elucidated with reference to the embodiments described hereinafter.

It will be appreciated by those skilled in the art that two or more of the above-mentioned embodiments, implementations, and/or aspects of the invention may be combined in any way deemed useful.

Modifications and variations of the system, the method, and/or of the computer program product, which correspond to the described modifications and variations of the system, can be carried out by a person skilled in the art on the basis of the present description.

### BRIEF DESCRIPTION OF THE DRAWINGS

In the drawings:

FIG. 1 schematically shows a light source and a relative flux sensor according to the first aspect of the invention,

FIG. 2a schematically shows a CIE xyz color space showing two obtained color point measurements,

FIG. 2b schematically shows the CIE xyz color space wherein other color point measurements of another embodiment are drawn,

FIG. 3 schematically shows a dimming curve including a determined point of the dimming curve,

FIG. 4 schematically shows a light source comprising three light emitters and a color-tunable-lamp control device according to the second aspect of the invention,

FIG. 5 schematically shows a color-tunable lamp according to the third aspect of the invention,

FIG. 6 schematically shows a luminaire according to the fourth aspect of the invention, and

FIG. 7 shows in a flow-diagram the method according to the fifth aspect of the invention.

It should be noted that items denoted by the same reference numerals in different Figures have the same structural features and the same functions, or are the same signals. Where the function and/or structure of such an item have been explained, there is no necessity for repeated explanation thereof in the detailed description.

The Figures are purely diagrammatic and not drawn to scale. Particularly for clarity, some dimensions are exaggerated strongly.

### DETAILED DESCRIPTION OF EMBODIMENTS

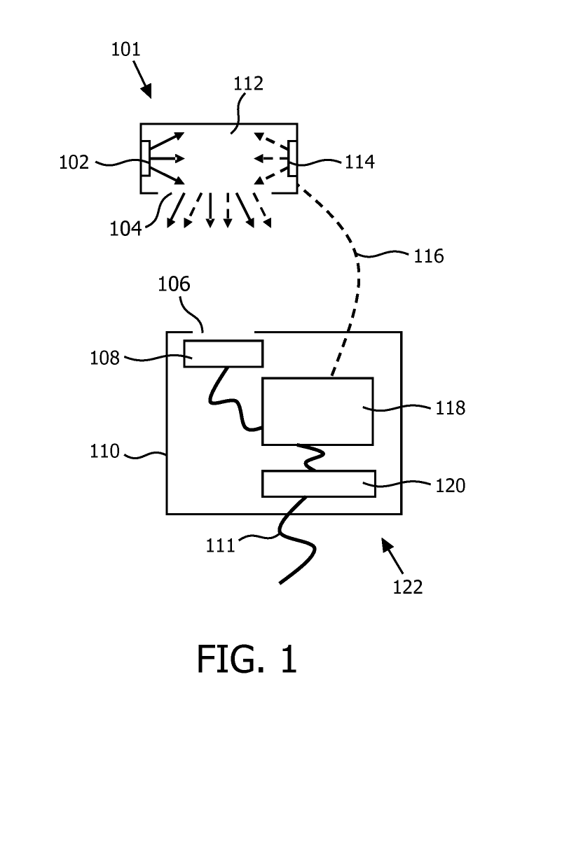

A first embodiment is shown in FIG. 1. A light source 101 is shown which comprises a first Light Emitting Diode (LED) 102 and a second LED 114. The first LED 102 emits light of a first color into a light mixing chamber 112 of the light source 101. The second LED 114 emits light of a second color into the light mixing chamber 112. The second color is different from the first color. The light mixing chamber 112 comprises a light exit window 104. Light which is a mixture of the first color and the second color is emitted through the light exit window 104 into the ambient of the light source 101.

A relative flux sensor 122 is shown as well. The relative flux sensor 122 comprises a light input 106 through which light may enter the relative flux sensor 122 to impinge on a color point sensor 108. The color point sensor 108 is coupled to a sensor controller 118 of the relative flux sensor 122. The sensor controller 118 is coupled to the output means 120.

The color point sensor 108 measures a color point of the light which enters the color point sensor 122 through the light input window 106. The color point is a coordinate in a color space which represents the color of the incident light. The sensor controller 118 receives a measuring signal from the color point sensor 108.

The sensor controller 118 provides a first signal via a communication channel 116 to the light source 101. The first signal comprises a dimming factor Da and a dimming factor Db. The dimming factor Da indicates a fraction of the maximum light intensity of the first LED 102 and the dimming factor Db indicates a fraction of the maximum light intensity of the second light emitter 114. When the light source 101 emits light according to the first signal, the first LED 102 emits at the fraction Da of its maximum light intensity and the second light emitter 114 emits at the fraction Db of its maximum light intensity, and the sensor controller 118 receives the measuring signal which represents the first color point. Subsequently, the sensor controller 118 provides a second signal via the communication channel 116 to the light source 101. The second signal comprises a dimming factor Dc which indicates a fraction of the maximum light intensity of the first LED 102. The second signal further comprises a dimming factor Dd which indicates a fraction of the maximum light intensity of the second light emitter. When the light source 101 emits light according to the second signal, the sensor controller 118 receives the measuring signal which represents a second color point. At least one of the dimming factors Da and Db is different from 0. The other one of the dimming factors Da and Db may also be different from 0. The dimming factors Dc and Dd are both different from 0. Further, the combination of dimming factors (Da, Db) is different from the combination of dimming factors (Dc, Dd), such that two different color points are measured. Further, it is to be noted that maximum light intensity of a light emitter and maximum flux of the light emitter are interchangeable in the context of this document.

The sensor controller 118 is further arranged to calculate within a color space model a ratio between a maximum flux emitted by the first LED 102 and a maximum flux emitted by the second LED 114. Inputs for the calculation are the first color point, the second color point, and the dimming factors Da, Db, Dc and Dd. The color point measurements are coordinates in the color space of the color space model. The color space model provides relations between the different variables of the model, allowing the calculation of the ratio. When the first color point, the second color point and the dimming factors are known, enough information is available to solve the relations of the color space model such that the ratio may be calculated. If e.g. the color space model is linear and the position of the color points linearly depends on the color points of the LEDs 102, 114, and if the LEDs 102, 114 are linear light emitters, it is relatively easy to calculate the ratio.

The output means 120 receives from the sensor controller 118 the ratio between the maximum flux of the first LED 102 and the maximum flux of the second LED 114. The output means 120 provides an output 111 of the relative flux sensor 122. The output 111 comprises at least the ratio between the maximum flux of the first LED 102 and the maximum flux of the second LED 114.

The light source 101 and the relative flux sensor 122 are separated in space, which means that the relative flux sensor 122 is not part of the light source 101. However, as discussed in another embodiment, the relative flux sensor 122 and the light source 101 may be integrated in one device. In the embodiment of FIG. 1 there is a communication channel 116 between the relative flux sensor 122 and the light source 101. The communication channel 116 may be a copper wire, a glass fiber or a wireless transmission channel. The light which falls through the light input window 106 on the color point sensor 108 originates mainly from the light source 101. However, it is probably impossible to exclude ambient light from falling on the color point sensor 108 when other light sources are present in the ambient. If the amount of light which does not originate from the light source 101 and which falls also on the color point sensor 108 is relatively small, the relative flux sensor 122 may still measure the color points relatively accurately and, thus, the ratio between the maximum flux of the first LED 102 and the maximum flux of the second light emitter 101 may still be calculated relatively accurately. In another embodiment, the color point sensor 108 may automatically correct for incident light from the ambient. Such a color point sensor 108 may obtain another measurement value when the light source 101 does not emit light and only ambient light impinges on the color point sensor 108. Subsequent measurements may be corrected by the color point sensor for said other measurement value of the ambient light.

It is to be noted that the relative flux sensor 122 may be used in combination with other light sources as well. The light source 101 is merely an example of a light source of which the relative flux sensor 122 may characterize parameters of the light emitters 102, 114. The embodiments of the light source 101 are not limited to light sources with a light mixing chamber 112 or to light sources which have LED light emitters. Other types of light emitters are for example Organic LEDs, color bulbs, light emitters provided with a color filter, etc.

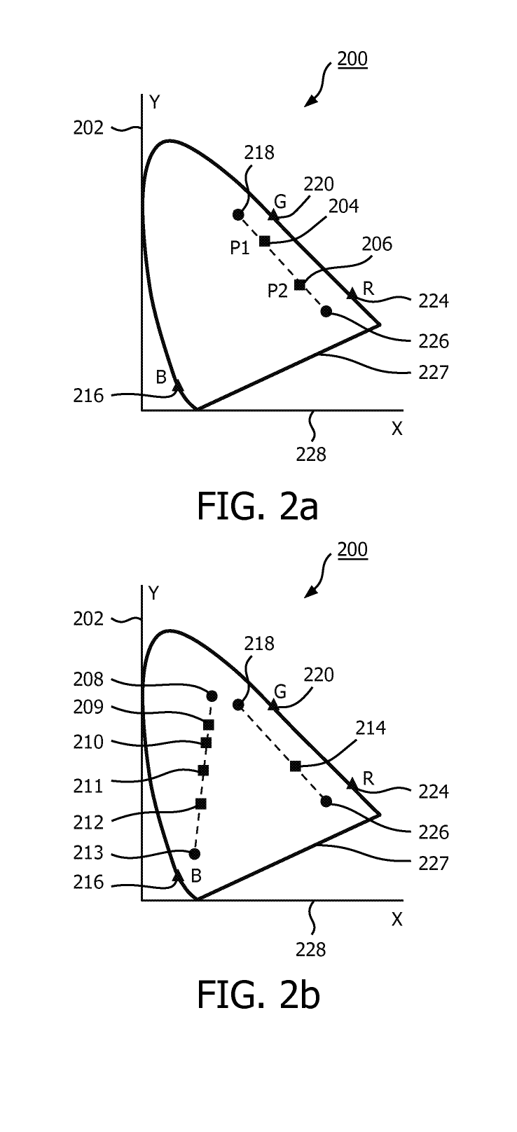

In FIG. 2a, a schematic drawing 200 of a color space is given. The color space is the CIE xyz color space. All colors of the CIE xyz color space may be represented by (x, y) coordinates, and in FIG. 2a the horizontal axis is the x-axis 228 and the vertical axis is the y-axis 202. The shape 227 is the envelope of all visible colors. The purest colors comprising only light of one wavelength are typically located at the border of shape 227. Pure blue light is located at a position close to a triangle 216, pure green light is located at a position close to a triangle 220, and pure red light is located at a position close to a triangle 224.

When referring back to the embodiment of FIG. 1, the obtained first color point measurement is the color point P1=(x3, y3) which is, for example, located at position 204 in the CIE xyz color space. Thus, when the light source 101 emits according to the first signal, which means that the first LED 102 emits at a dimming factor Da and the second LED 114 emits at a dimming factor Db, the color represented by P1 is the color emitted by the light source 101. The color represented by P1 is a mix of the color of the first LED 102, of which the color point is drawn at position 218, and the color of the second LED 114, of which the color point is drawn at position 226. The color point of the first LED 102 is represented by the coordinates (x1, y1) and the color point of the second LED 114 is represented by the coordinates (x2, y2). The obtained second color point measurement is the color point P2=(x4, y4) which is, for example, located at position 206 in the CIE xyz color space.

In the following paragraphs it is assumed that the light emission of the first LED 102 and the second LED 114 linearly depends on the maximum light intensity that may be emitted by the first LED 102 and the second LED 114 and that the dimming factor is the variable in the relation. Thus, with respect to the first LED 102: La=Da·Lₑₘ₁_{_{—}}ₘₐₓ and Lc=Dc·Lₑₘ₁_{_{—}}ₘₐₓ, wherein Lₑₘ₁_{_{—}}ₘₐₓ is the maximum light emission of the first LED 102, La and Lc is the light emission of the first LED 102 when the first signal and the second signal, respectively, is received by the light source 101 having the previously discussed dimming factors Da and Dc, respectively.

To calculate the ratio between the maximum flux emitted by the first LED 102 and the maximum flux emitted by the second LED 114, the color point (x1, y1) of the first LED 102 and the color point (x2, y2) of the second LED 114 have to be calculated first. This is done by means of the subsequent formulas:

$$x 1 = x 4 \frac{DbDc + DbDd \frac{y 3 ( DaDc + DaDd ) - y 4 ( DaDc + DbDc )}{y 4 ( DbDd + DaDd ) - y 3 ( DbDd + DbDc )}}{DbDc - DaDd} - x 3 \frac{DaDd + DbDd \frac{y 3 ( DaDc + DaDd ) - y 4 ( DaDc + DbDc )}{y 4 ( DbDd + DaDd ) - y 3 ( DbDd + DbDc )}}{DbDc - DaDd}$$

$$y 1 = y 4 \frac{DbDc + DbDd \frac{y 3 ( DaDc + DaDd ) - y 4 ( DaDc + DbDc )}{y 4 ( DbDd + DaDd ) - y 3 ( DbDd + DbDc )}}{DbDc - DaDd} - y 3 \frac{DaDd + DbDd \frac{y 3 ( DaDc + DaDd ) - y 4 ( DaDc + DbDc )}{y 4 ( DbDd + DaDd ) - y 3 ( DbDd + DbDc )}}{DbDc - DaDd}$$

$$x 2 = x 3 \frac{DbDc + DaDc \frac{y 4 ( DbDd + DaDd ) - y 3 ( DbDd + DbDc )}{y 3 ( DaDc + DaDd ) - y 4 ( DaDc + DbDc )}}{DbDc - DaDd} - x 4 \frac{DaDd + DaDc \frac{y 4 ( DbDd + DaDd ) - y 3 ( DbDd + DbDc )}{y 3 ( DaDc + DaDd ) - y 4 ( DaDc + DbDc )}}{DbDc - DaDd}$$

$$y 2 = y 3 \frac{DbDc + DaDc \frac{y 4 ( DbDd + DaDd ) - y 3 ( DbDd + DbDc )}{y 3 ( DaDc + DaDd ) - y 4 ( DaDc + DbDc )}}{DbDc - DaDd} - y 4 \frac{DaDd + DaDc \frac{y 4 ( DbDd + DaDd ) - y 3 ( DbDd + DbDc )}{y 3 ( DaDc + DaDd ) - y 4 ( DaDc + DbDc )}}{DbDc - DaDd}$$

Subsequently, the ratio between the flux emitted by the first LED 102 and the flux emitted by the second LED 114 is calculated, wherein the subsequent ratio relates to the moment when the first signal is received by the light source 101:

$$\frac{La}{Lb} = \frac{1 - \frac{x 2 y 3}{y 2 x 3}}{\frac{x 1 y 3}{y 1 x 3} - 1}$$

Or, the ratio between the flux emitted by the first LED 102 and the flux emitted by the second LED 114 is calculated, wherein the subsequent ratio relates to the moment when the second signal is received by the light source 101:

$$\frac{Lc}{Ld} = \frac{1 - \frac{x 2 y 4}{y 2 x 4}}{\frac{x 1 y 4}{y 1 x 4} - 1}$$

The ratio between the maximum flux emitted by the first LED 102 and the maximum flux emitted by the second LED 114 is subsequently calculated by means of one of the following formulas:

$$R = \frac{{L}_{em 1 \_max}}{{L}_{em 2 \_max}} = \frac{Db}{Da} \cdot \frac{La}{Lb} or R = \frac{{L}_{em 1 \_max}}{{L}_{em 2 \_max}} = \frac{Dd}{Dc} \cdot \frac{Lc}{Ld}$$

The sensor controller may comprise a calculation means for calculating the results of the formulas. Such a means for calculating the ratio may be a general purpose calculator which implements the function by means of software. Alternatively, it is also possible to implement the functions by means of hardware.

If, for example, the ratio R is 2, then the second light emitter emits twice as much light as the first light emitter does. Thus, the first light emitter may be characterized by means of the 3-tuple (x1, y1, 1.0) and the second light emitter by means of the 3-tuple (x2, y2, 0.5). The numbers may be used by a controller of a color-tunable lamp to control the emission of light of a desired color by the light source.

In another embodiment, the dimming factors Da and Dd are substantially equal to 100% and the dimming factors Db and Dc are substantially equal to 0%. The sensor controller 118 is further arranged for providing a third signal to the light source 101, wherein the third signal comprises the dimming factors Da and Dd, such that the LEDs 102, 114 of the light source 101 emit at their maximum light intensity when the third signal is received. The sensor controller receives the measuring signal representing a third color point when the light source 101 emits according to the third signal.

The color points of said another embodiment are drawn in FIG. 2b. When the light source 101 receives the first signal comprising the dimming factor Da=100% and the dimming factor Db=0%, the measured first color point is the color point 218 of the first LED 102. When the light source 101 receives the second signal comprising the dimming factor Dc=0% and the dimming factor Dd=100%, the measured second color point is the color point 226 of the second light emitter 114. When the light source 101 receives the third signal comprising the dimming factors Da=100% and Dd=100%, the measured third color point is a point 214 in between the first color point 218 and the second color point 226. The coordinates of the first color point are (x1, y1), the coordinates of the second color point are (x2, y2) and the coordinates of the third color point are (x12, y12). The ratio between the maximum flux Lₑₘ₁_{_{—}}ₘₐₓ emitted by the first LED 102 and the maximum flux Lₑₘ₂_{_{—}}ₘₐₓ emitted by the second LED 114 is subsequently calculated by means of:

$$R = \frac{{L}_{em 1 \_max}}{{L}_{em 2 \_max}} = \frac{1 - \frac{x 2 y 12}{y 2 x 12}}{\frac{x 1 y 12}{y 1 x 12} - 1}$$

Alternatively, other LEDs are used which have a different color point. The first LED 102 may have a color point 208, which is shown in FIG. 2b, and may be represented by the coordinates (x1_{100%}, y1_{100%}). The second LED 114 has a color point 213, which is shown in FIG. 2b, and the second color point may be represented by the coordinates (x2_{100%}, x2_{100%}). Thus, the light emitted by the first LED 102 is relatively green, and the light emitted by the second LED 114 is relatively blue. When the sensor controller generates the third signal and thus controls the first LED 102 and the second LED 114 to emit simultaneously at their maximum light intensity, a third color point 212 is obtained which is represented by the coordinates (x12_{100%}, y12_{100%}). The ratio between the maximum flux emitted by the first LED 102 and the maximum flux emitted by the second LED 114 may be calculated as follows:

$${R}_{100 \%} = \frac{{L}_{em 1 \_max}}{{L}_{em 2 \_max}} = \frac{1 - \frac{x {2 }_{100 \%} y {12}_{100 \%}}{y {2}_{100 \%} x {12}_{100 \%}}}{\frac{x {1}_{100 \%} y {12}_{100 \%}}{y {1}_{100 \%} x {12}_{100 \%}} - 1}$$

The sensor controller 118 is further arranged to determine the dimming curve of the second LED 114. The sensor controller 118 iteratively performs a plurality of measurements, wherein the third signal is provided to the light source and wherein, during every iteration, the dimming factor Da is 100% and the dimming factor Dd iterates through a plurality of predefined dimming factors ranging in between a minimum and a maximum dimming factor. For example, the plurality of predefined dimming factors are 75%, 50% and 25%. During every iteration, the light source 101 emits light of a color which is the mix of the first color and the second color. Because the fraction of the second color in the mix decreases, the color points move in the direction of the first color point 208. Thus, during the iterations, the color points 211, 210 and 209 are obtained, see FIG. 2b.

In the following discussion, during one of the iterations the dimming factor Dd is equal to 50%. If the light source emits light according to the dimming factor Da=100% and Dd=50%, the sensor controller 118 obtains a color point 210 which will be represented by the coordinates (x12₅₀, y12₅₀). Subsequently, the sensor controller 118 obtains a ratio between the flux emitted by the first LED 102 and the flux emitted by the second LED 114, by applying the formula

$${R}_{50 \%} = \frac{{L}_{em 1 \_max}}{{L}_{em 2 \_ 50 \%}} = \frac{1 - \frac{x {2 }_{100 \%} y {12}_{50 \%}}{y {2}_{100 \%} x {12}_{50 \%}}}{\frac{x {1}_{100 \%} y {12}_{50 \%}}{y {1}_{100 \%} x {12}_{50 \%}} - 1}$$

These steps of providing an adjusted third signal, obtaining an additional color point measurement and calculating a further ratio are performed iteratively, while the first light intensity is maintained constant at 100% and the second light intensity is iterated through the set of (75%, 50%, 25%).

Based on the calculated ratio_{100%}, the setting of 50% light intensity for the second LED 114 and the calculated ratio_{50%}, a point of the dimming curve of the second LED 114 may be calculated. First, an expected ratio_{50%} may be calculated, although this is not necessary. It is expected that the ratio_{50%} equals

$${expected\_ratio}_{50 \%} = \frac{1}{0.5} \cdot {ratio}_{100 \%} .$$

If the ratio_{50%}, which is based on the measurement during one of the iterations, differs from the expected_ratio_{50%} value, the 2-tuple (50%, 50%)=(intensity_in, intensity_out) is not a point on the dimming curve. Intensity_in is the intensity indicated by the second signal relative to the maximum intensity of the second LED 114 and intensity_out is the intensity (relative to the maximum intensity) which is really emitted by the second LED 114 when the second LED 114 receives the second signal indicating intensity_in. Intensity_out is calculated by:

$$intensity\_out = \frac{{ratio}_{100 \%}}{{ratio}_{50 \%}}$$

In the example, the second signal indicated 50% light emission. On the assumption that the previously determined ratio_{100%}=2, the expected_ratio_{50%}=(1/0.5)*2=4. However, while measuring, the real value for ratio_{50%}=2.666. Thus, the intensity_out=2/2.666=0.75, which means that when the second LED 114 receives a signal to emit at 50% of the maximum light intensity, the second LED 114 emits in fact at 75%. Thus, the point (50%, 75%) is a point on the dimming curve of the second LED 114.

In FIG. 2b more examples of color point measurements are presented, which are measured during the iterations and thus under the circumstances that the second LED 114 received a second signal indicating a light intensity in between the minimum and the maximum light intensity. For example, the color points indicated by 211, 210 and 209 are respectively the measurements of the color point when the second LED 114 received the second signal indicating a light intensity of 75%, 50% and 25%, respectively. Several points of the dimming curve may be obtained by performing the calculations discussed above.

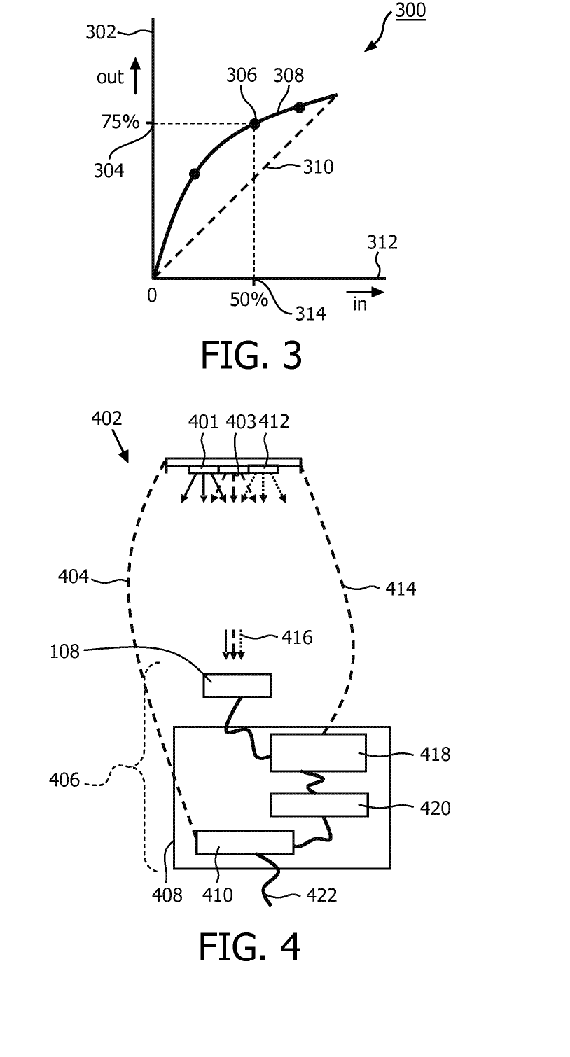

FIG. 3 shows a chart 300 of a dimming curve of a light emitter of a light source. The x-axis 312 represents the intensity_in value, which is the normalized intensity value indicated by an input signal of the light source. The y-axis 302 represents the normalized intensity output value, thus, the normalized amount of light which is really emitted when a signal is received which indicates a specific intensity_in value. If the light emitter and, for example, the behavior of the driving electronics of the light emitter are linear, one would expect a dimming curve according to dashed line 310. However, dimming curves may be non-linear, for example as a result of physical characteristics of the light emitter, or because of intended and/or unintended non-linearities of driving circuits which provide power to the light emitter in dependence on an input signal and/or non-linear behavior of the light emitters. In the example discussed in the context of FIG. 2b, the point 306 having an input value 315 of 50% and an output value 304 of 75%, is on the dimming curve 308. If several such points are known, the dimming curve 308 may be reconstructed by means of interpolation, extrapolation or curve fitting.

FIG. 4 shows another embodiment of a light source 402 and another embodiment of a control device 406 for a color-tunable lamp. The light source 402 comprises three Organic Light Emitting Diodes (OLEDs) which directly emit light into the ambient of the light source 402. The first OLED 401 emits light of a first color, the second OLED 403 emits light of a second color, and the third OLED 412 emits light of a third color. The first color, the second color and the third color are different from each other. If three primary colors, for example red, green and blue, are used, practically all colors may be emitted. In the example of FIG. 4, the three OLEDs are located next to each other and they all emit an amount of light in the same directions. Thus, the light of the three OLEDs is automatically mixed and at some distance from the light source 402 a substantially homogeneous mix of light 416 is obtained.

The control device 406 comprises the color point sensor 108, which is not integrated in the housing of the control device 406, but which is coupled via a wire to a sensor controller 418 of the control device 406. The color point sensor 108 receives light 416 from the light source 402, and because of a relatively large distance between the light source 402 and the color point sensor 108, a homogeneous mix 416 of colors emitted by the three OLEDs of the light source 402 impinges on the color point sensor 108. The color point sensor 108 measures the color point of the light 416 which impinges on the color point sensor 108 and provides a measuring signal to the sensor controller 418 comprising the measured color point.

The sensor controller 418 is coupled to an output means 420 and provides the output means with color point measurements and results of calculated ratios between fluxes. The output means 420 is coupled to a light source controller 410. The light source controller 410 receives the output means characteristics of the OLEDs and receives a user-input 422 which indicates a color which has to be emitted by the light source 402.

The light source controller 410 generates three signals to which is referred in this embodiment by signal a, signal b and signal c. The signals a, b and c are provided via a communication channel 404 to the light source 402 and they indicate a specific amount of light to be emitted by the OLED 102, the second OLED 403 and the third OLED 412, respectively. The light source controller generates the signals a, b and c on the basis of well known controllers which operate on the basis of the user-input 422 and characteristics of the first OLED 401, the second OLED 403 and the third OLED 412. These characteristics are provided by the output means 420 and comprise a first color point, a second color point, and a third color point of the first OLED 401, the second OLED 403 and the third OLED 412 respectively. The characteristics further comprise a first ratio between the maximum flux of the first OLED 401 and the maximum flux of the second OLED 403, and a second ratio between the maximum flux of the first OLED 401 and the maximum flux of the third OLED 412.

In the example of FIG. 4, the sensor controller 418 is capable of determining the first ratio and the second ratio, which are provided via the output means 420 to the light source controller 410. Two embodiments to determine the first ratio and the second ratio are discussed hereinafter:

In a first embodiment, the sensor controller 418 provides a first signal to the light source 402 via a communication channel 414. The first signal comprises dimming factors D1, D2 and D3, which indicate a fraction of the maximum light intensity of the first OLED 401, the second OLED 403 and the third OLED 412, respectively. When the light source 402 emits light according to the first signal, the sensor controller 418 receives the measuring signal from the color point sensor 108 representing a first color point. Subsequently, the sensor controller 418 provides a second signal to the light source 402 via a communication channel 414. The second signal comprises dimming factors D4, D5 and D6, which indicate a fraction of the maximum light intensity of the first OLED 401, the second OLED 403 and the third OLED 412, respectively. When the light source 402 emits according to the second signal, the sensor controller 418 receives the measuring signal from the color point sensor 108 representing a second color point. Subsequently, the sensor controller 418 provides a fourth signal to the light source 402 via a communication channel 414. The fourth signal comprises dimming factors D7, D8 and D9, which indicate a fraction of the maximum light intensity of the first OLED 401, the second OLED 403 and the third OLED 412, respectively. When the light source 402 emits according to the fourth signal, the sensor controller 418 receives the measuring signal from the color point sensor 108 representing a fourth color point. Finally, the sensor controller 418 calculates a first ratio between the maximum flux of the first OLED 401 and the maximum flux of the second OLED 403 on the basis of the dimming factors D1 to D9, the first color point, the second color point and the fourth color point. Additionally, the sensor controller 418 may be arranged to calculate a second ratio between the maximum flux of the first OLED 401 and the maximum flux of the third OLED 412 on the basis of the dimming factors D1 to D9, the first color point, the second color point and the fourth color point. Additionally, the sensor controller 418 may be arranged to calculate a third ratio between the maximum flux of the second OLED 403 and the maximum flux of the third OLED 412 on the basis of the dimming factors D1 to D9, the first color point, the second color point and the fourth color point. Alternatively, the third ratio may also be deducted from the first ratio and the second ratio.

Alternatively, in a second embodiment, the dimming factors D1, D5 and D9 are 100% and the dimming factors D2, D3, D4, D6, D7, and D8 are 0%. The sensor controller 418 is further arranged to provide a fifth signal to the light source 402. The fifth signal comprises the dimming factors D1, D5 and D9. When the light source 402 emits according to the fifth signal, the sensor controller 418 receives the measuring signal from the color point sensor 108 representing a fifth color point. The sensor controller 418 is arranged to calculate the first ratio between the maximum flux of the first OLED 401 and the maximum flux of the second OLED 403 on the basis of the dimming factors D1 to D9 and the first color point, the second color point, the fourth color point and the fifth color point. Additionally, the sensor controller may be arranged to calculate the second ratio between the maximum flux of the first OLED 401 and the maximum flux of the third OLED 412 on the basis of the dimming factors D1 to D9 and the first color point, the second color point, the fourth color point, and the fifth color point.

In the second embodiment, the first color point, the second color point, the fourth color point and the fifth color point may be represented by the coordinates (x1, y1), (x2, y2), (x3, y3) and (x123, y123) respectively. The sensor controller 418 may calculate the first ratio between the maximum flux Y1 of first OLED 401 and the maximum flux Y2 of the second OLED 403 by means of a formula:

$${ratio}_{1 - 2} = \frac{Y 1}{Y 2} = \frac{y 1 \cdot ( \begin{matrix}x 2 \cdot y 3 - x 3 \cdot y 2 + x 3 \cdot y 123 - \\ x 123 \cdot y 3 + x 123 \cdot y 2 - x 2 \cdot y 123\end{matrix} )}{y 2 \cdot ( \begin{matrix}x 123 \cdot y 3 - x 3 \cdot y 123 + x 3 \cdot y 1 - \\ x 1 \cdot y 3 + x 1 \cdot y 123 - x 123 \cdot y 1\end{matrix} )}$$

and the sensor controller 418 may calculate the second ratio between the maximum flux Y1 of the first OLED 401 and the maximum flux Y3 of the third OLED 412 by means of a formula:

$${ratio}_{1 - 3} = \frac{Y 1}{Y 3} = \frac{y 1 \cdot ( \begin{matrix}x 2 \cdot y 3 - x 3 \cdot y 2 + x 3 \cdot y 123 - \\ x 123 \cdot y 3 + x 123 \cdot y 2 - x 2 \cdot y 123\end{matrix} )}{y 3 \cdot ( \begin{matrix}x 2 \cdot y 123 - x 123 \cdot y 2 + x 123 \cdot y 1 - \\ x 1 \cdot y 123 + x 1 \cdot y 2 - x 2 \cdot y 1\end{matrix} )}$$

It is to be noted that a third ratio between the maximum flux Y2 emitted by the second light emitter 114 and the maximum flux Y3 emitted by the third light emitter 412 may be calculated by means of the formula:

$${ratio}_{2 - 3} = \frac{Y 2}{Y 3} = \frac{y 2 \cdot ( \begin{matrix}x 123 \cdot y 3 - x 3 \cdot y 123 + x 3 \cdot y 1 - \\ x 1 \cdot y 3 + x 1 \cdot y 123 - x 123 \cdot y 1\end{matrix} )}{y 3 \cdot ( \begin{matrix}x 2 \cdot y 123 - x 123 \cdot y 2 + x 123 \cdot y 1 - \\ x 1 \cdot y 123 + x 1 \cdot y 2 - x 2 \cdot y 1\end{matrix} )}$$

However, it is not necessary to calculate the third ratio on the basis of this formula because the third ratio may be derived from the first ratio and the second ratio.

It is to be noted that the determining of the characteristics of the first OLED 401, the second OLED 403 and the third OLED 412 is performed at another moment in time than the controlling of the light source to emit light according to the user-input. Thus, at a first interval of time the sensor controller 418 provides signals to the light source 402, while at a second interval of time the light source controller 410 provides signals to the light source 402. The first interval and the second interval do not overlap. The determination of the characteristics of the OLEDs 401, 403, 412 may be done relatively fast and therefore the length of the first interval with respect to the length of the second interval is relatively short.

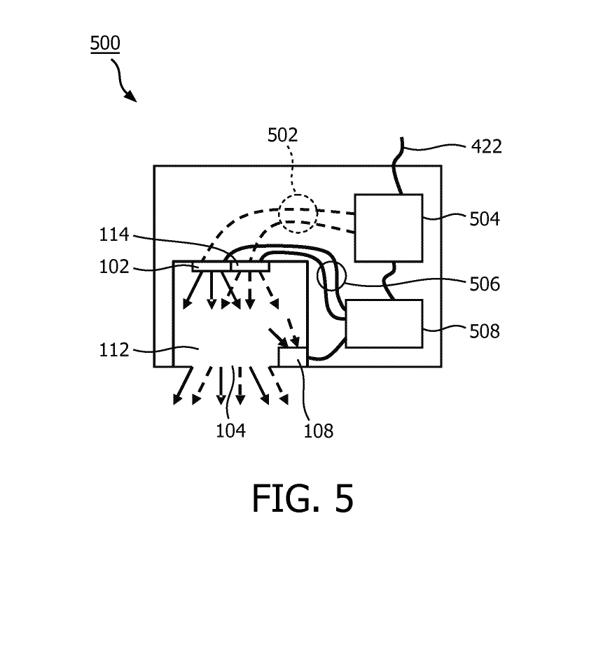

FIG. 5 presents an embodiment of a color-tunable lamp 500 according to a third aspect of the invention. The color-tunable lamp 500 comprises a light source which comprises the first LED 102 and the second LED 114. Both LEDs 102, 114 emit light in a light mixing chamber 112. The light mixing chamber 112 has a light exit window 104 through which a combination of light from the first LED 102 and from the second LED 114 is emitted into the ambient of the color tunable lamp 500. Inside the light mixing chamber 112, close to the light exit window 104, a color point sensor 108 is provided which is capable of measuring the color point of the mixed light which is emitted through the light exit window 104. The color point sensor 108 is coupled to a sensor controller 508 which has the same function as the sensor controller 118 of the embodiment of FIG. 1 and which comprises an output means which provides output to a light source controller 504. The sensor controller 508 is coupled to the first LED 102 and the second LED 114 via a communication channel 506. The light source controller 504 receives from the sensor controller 508 characteristics of the LEDs, comprising at least a color point of the first LED 102, a color point of the second LED 114 and a ratio between a maximum flux emitted by the first LED 102 and a maximum flux emitted by the second LED 114. The light source controller 504 receives a user-input 422 which indicates a desired color for the light which is emitted into the ambient of the color-tunable lamp 500. The light source controller 504 generates, on the basis of the user-input 422 and on the basis of the received characteristics of the light emitters, two signals which are provided via a communication channel 502 to the first LED 102 and the second LED 114.

In an embodiment, the characteristics of the first LED 102 and the characteristics of the second LED 114 are determined when the color-tunable device 500 is being switched on, i.e. when the color-tunable device 500 changes to an operational mode. The determination of the characteristics of the first LED 102 and the second LED 114 may be performed relatively quickly, for example, the first LED 102 may be switched on for 20 ms, during which the first color point is measured, after which the second LED 114 is switched on for 20 ms, during which the second color point is measured, and the first LED 102 and the second LED 114 are simultaneously switched on for 20 ms, during which the third color point is measured. When the LEDs 102, 114 are turned on for such short periods, the user may experience very short flashes but the normal use of the color-tunable lamp is not limited. In another embodiment, the light source controller 504 may have a memory in which the characteristics of the first LED 102 and of the second LED 114 are stored, for example, during periods of time when the color-tunable lamp 500 is not in an operational mode, i.e. when the color-tunable lamp 500 is switched off. In such cases the characteristics of the first LED 102 and the second LED 114 do not have to be determined every time the color-tunable device 500 is switched on to an operational mode. However, because of possible deterioration of the first LED 102 and/or second LED 114, it is advised to perform the determination of the characteristics at regular time intervals, for example, every month, or, for example, after a predefined number of operational hours.

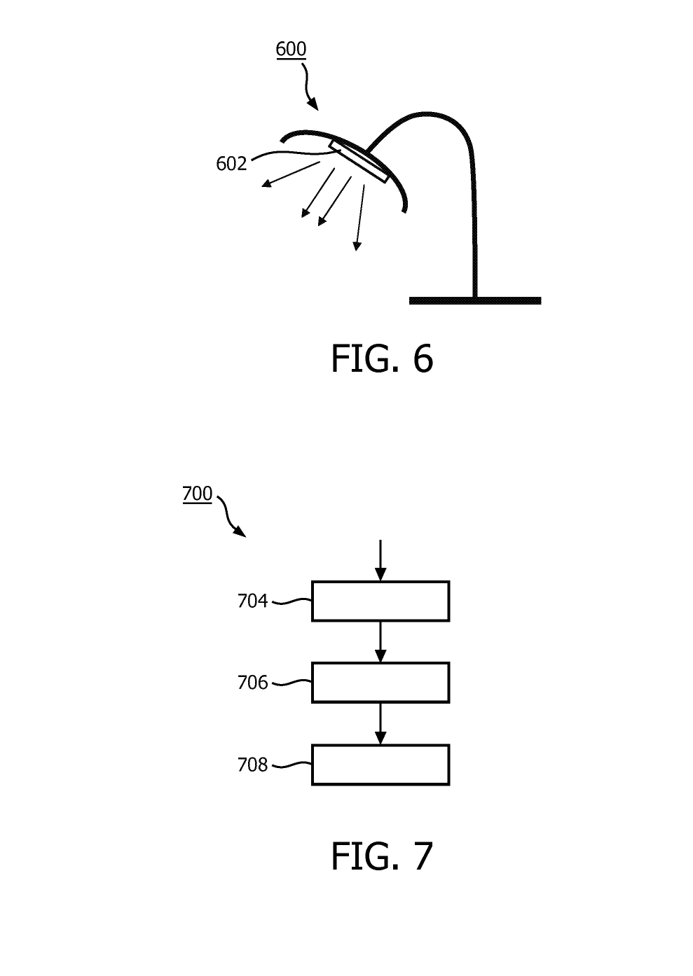

FIG. 6 schematically shows a luminaire 600 according to the fourth aspect of the invention. The luminaire 600 comprises a color-tunable lamp 602 according to the third aspect of the invention.

FIG. 7 schematically shows a flow diagram 700 of a method according to the fifth aspect of the invention. In step 704 a first signal is provided to the light source. The first signal comprising a dimming factor D1 and a dimming factor D2. The dimming factor D1 and the dimming factor D2 indicating a fraction of the maximum light intensity of the first light emitter and the second light emitter, respectively. In step 704 the measuring signal representing a first color point is received when the light source emits light according to the first signal. In step 706 a second signal is provided to the light source, the second signal comprising a dimming factor D4 and a dimming factor D5. The dimming factor D4 and the dimming factor D5 indicating a fraction of the maximum light intensity of the first light emitter and the second light emitter, respectively. In step 706 the measuring signal representing a second color point is received when the light source emits light according to the second signal. In step 708 a ratio between a maximum flux of the first light emitter and a maximum flux of the second light emitter is calculated within a color space model on the basis of the first color point, the second color point, the dimming factors D1, D2, D4 and D5.

It is to be noted that the steps 704 and 706 may be performed in another order. However, steps 708 can only be performed after performing both steps 704 and 706.

It will be appreciated that the invention also extends to computer programs, particularly computer programs on or in a carrier, adapted for putting the invention into practice. The program may be in the form of a source code, an object code, a code intermediate source and object code such as in partially compiled form, or in any other form suitable for use in the implementation of the method according to the invention. It will also be appreciated that such a program may have many different architectural designs. For example, a program code implementing the functionality of the method or system according to the invention may be subdivided into one or more subroutines. Many different ways to distribute the functionality among these subroutines will be apparent to the skilled person. The subroutines may be stored together in one executable file to form a self-contained program. Such an executable file may comprise computer executable instructions, for example processor instructions and/or interpreter instructions (e.g. Java interpreter instructions). Alternatively, one or more or all of the subroutines may be stored in at least one external library file and linked with a main program either statically or dynamically, e.g. at run-time. The main program contains at least one call to at least one of the subroutines. Also, the subroutines may comprise function calls to each other. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth. These instructions may be subdivided into subroutines and/or be stored in one or more files that may be linked statically or dynamically.

The carrier of a computer program may be any entity or device capable of carrying the program. For example, the carrier may include a storage medium, such as a ROM, for example a CD ROM or a semiconductor ROM, or a magnetic recording medium, for example a floppy disc or hard disk. Further, the carrier may be a transmissible carrier such as an electrical or optical signal, which may be conveyed via electrical or optical cable or by radio or other means. When the program is embodied in such a signal, the carrier may be constituted by such a cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A relative flux sensor comprising:
a color point sensor for measuring a color point in a color space of light emitted by a light source comprising a first light emitter for emitting light of a first color and a second light emitter for emitting light of a second color being different from the first color, the light source being arranged for emitting light of a controllable color being a mix of light of the first color and light of the second color,
a sensor controller coupled to the color point sensor for receiving a measuring signal and being arranged for
i) providing a first signal to the light source, the first signal comprising a dimming factor D1 and a dimming factor D2, the dimming factor D1 and the dimming factor D2 indicating a fraction of a maximum flux of the first light emitter and the second light emitter, respectively, and receiving the measuring signal representing a first color point when the light source emits light according to the first signal, wherein at least one of the dimming factors D1 and D2 is different from 0,
ii) providing a second signal to the light source, the second signal comprising a dimming factor D4 and a dimming factor D5, the dimming factor D4 and the dimming factor D5 indicating a fraction of the maximum flux of the first light emitter and the second light emitter, respectively, and receiving the measuring signal representing a second color point when the light source emits light according to the second signal, wherein both dimming factors D4 and D5 are different from 0,
iii) calculating within a model of the color space a ratio between a maximum flux of the first light emitter and a maximum flux of the second light emitter on the basis of the first color point, the second color point, the dimming factors D1, D2, D4 and D5 wherein the model is a mathematical color space model which provides relations between physical parameters of spectra of wavelengths and the coordinates of colors in the color space.

2. A relative flux sensor according to claim 1, wherein
the sensor controller is further arranged for providing a third signal to the light source, the third signal comprising a dimming factor Da substantially equal to 0% and the dimming factor Db substantially equal to 100%, the dimming factor Da and the dimming factor Db indicating a fraction of the maximum flux of the first light emitter and the second light emitter respectively, and receiving the measuring signal representing a third color point when the light source emits light according to the third signal,
the dimming factor D1 is substantially equal to 100%, the dimming factor D2 is substantially equal to 0%,
the step of calculating the ratio between the maximum flux of the first light emitter and the maximum flux of the second light emitter is further based on the third color point and the dimming factors Da and Db.

3. A relative flux sensor according to claim 2, wherein
the dimming factor D4 is substantially equal to 100% and the dimming factor D5 is substantially equal to 100%.

4. A relative flux sensor according to claim 3, wherein the first color point, the second color point and the third color point are represented by respective coordinates (x1, y1), (x12, y12) and (x2, y2) in a color space of a CIE xyz color space model, and wherein the ratio between the maximum flux Y1 of the first light emitter and the maximum flux Y2 of the second light emitter is calculated by
$$ratio = \frac{Y 1}{Y 2} = \frac{1 - \frac{x 2}{y 2} \cdot \frac{y 12}{x 12}}{\frac{x 1}{y 1} \cdot \frac{y 12}{x 12} - 1} .$$

5. A relative flux sensor according to claim 1, wherein the calculation of the ratio between the maximum flux of the first light emitter and the maximum flux of the second light emitter comprises calculating a color point of the first light emitter and calculating a color point of the second light emitter.

6. A relative flux sensor according to claim 1, wherein
the light source further comprises a third light emitter emitting a third color being different from the first color and being different from the second color,
the first signal further comprises a dimming factor D3 indicating a fraction of the maximum flux of the third light emitter,
the second signal further comprises a dimming factor D6 indicating a fraction of the maximum flux of the third light emitter,
the sensor controller is further arranged for providing a fourth signal to the light source, the fourth signal comprising a dimming factor D7, a dimming factor D8 and a dimming factor D9, the dimming factor D7, the dimming factor D8 and the dimming factor D9 indicating a fraction of the maximum light flux of the first light emitter, the second light emitter and the third light emitter, respectively, and receiving the measuring signal representing a fourth color point when the light source emits light according to the fourth signal,
the calculating of the ratio between the maximum flux of the first light emitter and the maximum flux of the second light emitter is further based on the dimming factors D3, D6, D7, D8 and D9 and the fourth color point.

7. A relative flux sensor according to claim 6, wherein
the sensor controller is further arranged for providing a fifth signal to the light source, the fifth signal comprising dimming factors Dc being substantially equal to 0%, Dd being substantially equal to 100% and De being substantially equal to 0%, the dimming factor Dc, the dimming factor Dd and the dimming factor De indicating a fraction of the maximum light flux of the first light emitter, the second light emitter and the third light emitter respectively, and receiving the measuring signal representing a fifth color point when the light source emits light according to the fifth signal,
the dimming factors D1, D9 are substantially equal to 100% and the dimming factors D2, D3, D7, D8 are substantially equal to 0%,
the calculation of the ratio between the maximum flux of the first light emitter and the maximum flux of the second light emitter is further based on the fifth color point and the dimming factors Dc, Dd and De.

8. A relative flux sensor according to claim 6, wherein the dimming factors D3, D4 and D5 are substantially equal to 100%.

9. A relative flux sensor according to claim 3, wherein the sensor controller is further arranged for
defining a plurality of dimming factors in between a minimum and a maximum dimming factor,
iteratively performing for each one of the plurality of defined dimming factors the steps of providing the second signal to the light source, receiving the measuring signal representing the second color point, and calculating a dimming ratio between the maximum flux of the first light emitter and a dimmed flux of the second light emitter, wherein the dimming factor D5 iterates through the plurality of defined dimming factors in the subsequent iterations,
calculating points of a dimming curve of the second light emitter on the basis of the plurality of defined dimming factors, the plurality of the calculated dimming ratios between the maximum flux of the first light emitter and the dimmed flux of the second light emitter and the calculated ratio between the maximum flux of the first light emitter and the maximum flux of the second light emitter.

10. A relative flux sensor according to claim 8, wherein the sensor controller is further arranged for reconstructing the dimming curve of the second light emitter on the basis of the calculated points of the dimming curve.

11. (canceled)

12. Color-tunable lamp comprising:
comprising a first light emitter for emitting light of a first color and a second light emitter for emitting light of a second color being different from the first color, the light source being arranged for emitting light according to a received signal that comprises dimming factors which indicate a fraction of the maximum flux of respective light emitters, and
a control device, comprising
the relative flux sensor according to claim 1, and
a light source controller configured for
i) receiving the first color point, the second color point and the ratio between the maximum flux of the first light emitter and the maximum flux of the second light emitter,
ii) receiving a user-input indicating a color to be emitted by the color-tunable lamp,
iii) generating a sixth signal comprising a dimming factor D10 and a dimming factor D11 to obtain, when the light source emits light according to the sixth signal, an emitted color indicated by the user-input, the generating being performed on the basis of the first color point, second color point and the ratio between the maximum flux of the first light emitter and the maximum flux of the second light emitter, the dimming factor D10 and the dimming factor D11 indicating a fraction of the maximum flux of the first light emitter and the second light emitter, respectively, and
iv) providing the sixth signal to the light source.

13. Luminaire comprising the color-tunable lamp according to claim 12.

14-15. (canceled)
